(19) United States
(12) Patent Application Publication
(10) Pub. No.: US 2026/0079305 A1
(43) Pub. Date: Mar. 19, 2026

(54) METHOD AND SYSTEM FOR PACKAGING FIBER ARRAYS

(71) Applicant: RAM Photonics Industrial, LLC, Webster, NY (US)

(72) Inventors: Per Adamson, Conesus, NY (US); Robert Balonek, Rochester, NY (US); Michael Cinquino, Conesus, NY (US); Joseph Lawson, Rochester, NY (US); John R. Marciante, Webster, NY (US)

(73) Assignee: RAM Photonics Industrial, LLC, Webster, NY (US)

(21) Appl. No.: 19/330,662

(22) Filed: Sep. 16, 2025

Related U.S. Application Data
(60) Provisional application No. 63/696,239, filed on Sep. 18, 2024.

(51) Int. Cl. G02B 6/36

(52) U.S. Cl. CPC G02B 6/3628

(57) ABSTRACT

A sealed fiber array package includes a substrate and a fiber array including a plurality of optical fibers. Each optical fiber of the plurality of optical fibers is bonded to the substrate. The sealed fiber array package also includes a sheath at least partially surrounding the fiber array. The sheath has a first end abutting the substrate and a second end distal from the substrate. The sealed fiber array package further includes a first seal disposed at the first end of the sheath and a second seal disposed at the second end of the sheath.

### CROSS-REFERENCES TO RELATED APPLICATIONS

This application claims priority to U.S. Provisional Patent Application No. 63/696,239, filed on Sep. 18, 2024, entitled “Method and System for Packaging Fiber Arrays,” the disclosure of which is hereby incorporated by reference in its entirety for all purposes.

### BACKGROUND OF THE INVENTION

Optical fiber connectors generally utilize epoxy to join an optical fiber to an optical component such as an optical waveguide on a photonic device or another optical fiber. In some implementations, epoxy can be used to form a seal around the glass portion of the optical fiber and form a low-loss optical connector. Despite the progress made in the area of optical fiber connectors, there is a need in the art for improved methods and systems related to optical fiber connectors.

### SUMMARY OF THE INVENTION

The present disclosure relates generally to methods and systems related to optical systems including arrays of optical fibers. More particularly, embodiments of the present invention provide methods and systems for packaging of fiber arrays. The disclosure is applicable to a variety of applications in lasers and optics, including fiber laser implementations.

According to an embodiment of the present invention, a sealed fiber array package is provided. The sealed fiber array package includes a substrate and a fiber array including a plurality of optical fibers. Each optical fiber of the plurality of optical fibers is bonded to the substrate. The sealed fiber array package also includes a sheath at least partially surrounding the fiber array. The sheath has a first end abutting the substrate and a second end distal from the substrate. The sealed fiber array package further includes a first seal disposed at the first end of the sheath and a second seal disposed at the second end of the sheath.

According to another embodiment of the present invention, a sealed fiber array package is provided. The sealed fiber array package includes a substrate and a fiber array including a plurality of optical fibers. Each optical fiber of the plurality of optical fibers is bonded to the substrate. The sealed fiber array package also includes a sheath at least partially surrounding the fiber array. The sheath includes a first section disposed on a first side of the fiber array and including a set of first joints, a second section disposed on a second side of the fiber array opposing the first side and including a set of second joints, wherein the first joints are bonded to the second joints, and a set of half-annuluses joined to the first section and the second section and defining an aperture, wherein the fiber array extends through the aperture. A first seal is formed between the substrate and the sheath and a second seal formed in the aperture.

According to a particular embodiment of the present invention, a method of fabricating a sealed fiber array package is provided. The method includes providing a substrate, providing a fiber array including a plurality of optical fibers, and bonding each of the plurality of optical fibers to the substrate. The method also includes positioning a sheath at least partially surrounding the fiber array. The sheath comprises a first end abutting the substrate and a second end distal from the substrate. The method further includes bonding the first end of the sheath to the substrate and bonding the second end of the sheath to each of the plurality of optical fibers.

Numerous benefits are achieved by way of the present disclosure over conventional techniques. For example, embodiments of the present invention provide a sealed fiber array package that utilizes the stiffness provided by a sheath (e.g., a glass tube) to improve the lifetime of welded joints formed between optical fibers and a substrate by reducing or eliminating static fatigue of the weld joint, increasing the stiffness-mass ratio, and improving vibrational performance. Moreover, some embodiments of the present invention can utilize the sheath, or multiple sheaths, to provide an athermalized, sealed fiber array package. These and other embodiments of the disclosure, along with many of its advantages and features, are described in more detail in conjunction with the text below and corresponding figures.

### BRIEF DESCRIPTION OF THE DRAWINGS

FIG. 1 is a simplified schematic diagram of a fiber array surrounded by a sheath according to an embodiment of the present invention.

FIG. 2 is a simplified schematic diagram of a sealed fiber array package according to an embodiment of the present invention.

FIG. 3 is a simplified schematic diagram of a fiber array surrounded by a sheath capped by a disk according to an embodiment of the present invention.

FIG. 4 is a simplified schematic diagram of a sealed fiber array package including a sheath capped by a disk according to an embodiment of the present invention.

FIG. 5 is a simplified schematic diagram of a fiber array surrounded by two sheaths according to an embodiment of the present invention.

FIG. 6 is a simplified schematic diagram of a sealed fiber array package including two sheaths according to an embodiment of the present invention.

FIG. 7 is a simplified, partially transparent schematic diagram of a sealed fiber array package according to an embodiment of the present invention.

FIG. 8 is a simplified schematic diagram of a sealed fiber array package mounted using a boot according to an embodiment of the present invention.

FIG. 9 is a simplified schematic diagram of a fiber array partially surrounded by a sheath with alignment features according to an embodiment of the present invention.

FIG. 10A is a simplified schematic diagram of a conical sheath from a bottom perspective according to an embodiment of the present invention.

FIG. 10B is a simplified schematic diagram of the conical sheath from a top perspective according to an embodiment of the present invention.

FIG. 11 is a simplified schematic plan view of a sheath with interdigitated support combs according to an embodiment of the present invention.

FIG. 12 is a simplified flowchart illustrating a method of fabricating a sealed fiber array package according to an embodiment of the present invention.

### DETAILED DESCRIPTION OF SPECIFIC EMBODIMENTS

The present disclosure relates generally to methods and systems related to optical systems including arrays of optical fibers. More particularly, embodiments of the present invention provide methods and systems for packaging of fiber arrays. The disclosure is applicable to a variety of applications in lasers and optics, including fiber laser implementations.

In fiber connectors, heavy reliance is made on epoxy. Typically, the structure of the connector includes epoxy to (a) hold the fiber in place, (b) provide mechanical strain relief, and (c) encapsulate the glass to provide a hermetic barrier against humidity. As a result, the epoxy generally covers the glass portion of the fiber and the fiber coating, which itself provides strain relief to the fiber.

In embodiments of the present invention, fibers making up a fiber array are laser welded to a substrate, for example, a microlens array (MLA). As a result, to hold the fiber in place, no epoxy is used at the location where the fiber is bonded to the substrate since the fiber is held in place by the laser weld. Welding provides advantages including precision alignment of the fiber location and no change of the fiber location over time. In contrast, conventional epoxying of the fiber in a hole requires some clearance since the hole is larger than fiber and this leads to uncertainty in the fiber position for epoxied fibers. Also, the epoxy can degrade over time, leading to drift in the fiber location and reduced connection reliability.

Embodiments of the present invention provide strain relief in order to avoid the welded fibers from snapping off the substrate and hermetic sealing of the uncoated section of the fiber since the coating is removed in the section of fiber that is welded. In particular, the embodiments described herein solve many challenges related to fiber arrays in which the fibers in the fiber array are welded to a substrate. For instance, since there are many fibers making up the fiber array, each of the fibers is provided with strain relief and hermetically protected. This is performed using a substrate to which the fibers are welded that has a large transverse spatial extent. Moreover, since the fibers in the fiber array are characterized by close packing density (e.g., 300 μm center-to-center spacing for 125 μm diameter fibers results in a small gap of only 175 μm between fibers), a sealant, e.g., epoxy, would need to be able to flow in between the fibers.

The large spatial extent of the substrate and the large number of fibers would result in a large amount of epoxy being used if conventional techniques were utilized. This would result in material shrinkage during curing of the epoxy, thereby producing high levels of stress. In fact, the stress produced between fibers could result in one or more fibers being separated from the substrate to which they were previously welded. Moreover, this stress can result in the welding face of the substrate deforming, causing optical aberrations and, if the substrate is thin enough (e.g., an MLA), cracking of the substrate. Additionally, a mismatch in the coefficient of thermal expansion (CTE) between the optical fibers and the epoxy would become important, presenting similar problems resulting from material shrinkage, but due to temperature changes. Together, these problems prevent conventional bonding techniques from achieving telecommunications testing standards, including surviving 85% relative humidity at 85° C. and −40° C., referred to as 85/85 and −40 testing.

The inventors have determined that in order to address these challenges, strain relief and hermetic sealing can be separated into two separate functions that do not have to be accomplished by a single solution. Accordingly, embodiments of the present invention provide a solution in which the fiber array is encapsulated by a sheath (e.g., a sheath of glass). One end of the sheath is bonded to the substrate (e.g., using epoxy) and the other end of the sheath is bonded to the fibers in the fiber array (e.g., using epoxy). The separation of the bonding locations enables the location at which the fibers are bonded to each other and the sheath to provide strain relief while the separately bonded ends of the sheath provide a hermetic seal inside the sheath, including the locations where the exposed fibers (i.e., uncoated fibers) are welded to the substrate.

As described more fully herein, the use of a glass sheath provides a perfect CTE match to glass fibers, which aids in surviving 85/85 and −40 testing. Thus, embodiments of the present invention contrast with conventional approaches that bond the optical fibers to the substrate using epoxy. In these conventional approaches, the CTEs of the epoxy and that of the glass of the optical fibers and the substrate are different. These different CTEs will typically result in the epoxy and glass expanding at such different rates during heat cycling that the fibers can be detached from the substrate. Moreover, utilizing embodiments of the present invention, the CTE of the epoxy is not critical and the epoxy or other sealant can be selected to meet 85/85 and −40 testing. Additionally, epoxy cure shrinkage can become a non-critical factor.

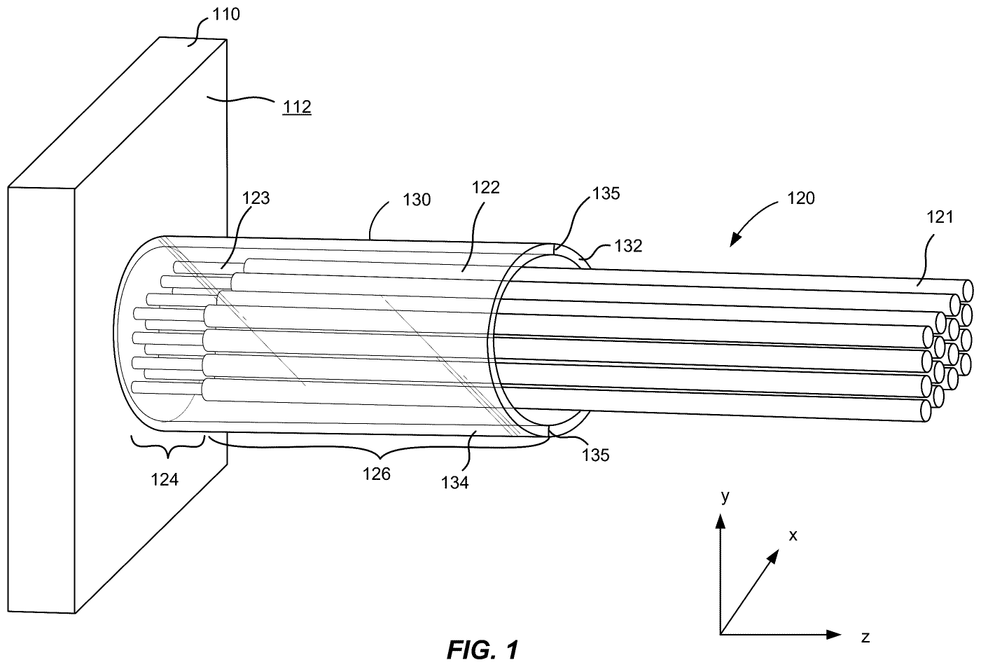

FIG. 1 is a simplified schematic diagram of a fiber array surrounded by a sheath according to an embodiment of the present invention. Referring to FIG. 1, a substrate 110 has a plurality of optical fibers 120, also referred to as a fiber array bonded to the substrate 110. In the embodiment illustrated in FIG. 1, each of the plurality of optical fibers 120 is welded to a welding surface 112 of the substrate 110. Individual optical fiber 121 is illustrated as one of the plurality of optical fibers 120. In some embodiments, optical fibers with a coated diameter of 250 μm are utilized. For these optical fibers, when the coating is removed, the diameter of the uncoated fiber is 125 μm. In other embodiments, optical fibers with different coated and uncoated diameters are utilized.

The coating 122 on each of the optical fibers, which can be referred to as fibers, is removed at an uncoated end portion 124 of the optical fiber adjacent the substrate 110 in order to expose the glass component 123 of the individual optical fiber 121. The length of the end portion is typically, one to several microns in length. The uncoated end of the optical fiber is then bonded or welded to the substrate 110.

In some embodiments, the substrate is an MLA that includes multiple lenslets. Each lenslet may be a microlens. A microlens may be a small lens, generally with a diameter less than a millimeter (mm) and as small as 10 μm. Each of the lenslets may be a single microlens with one planar surface and one convex (e.g., spherical) surface to refract light. In some cases, the lenslets may be or include several layers of optical material to achieve the desired optical properties. In some embodiments, the MLA may be a one-dimensional or two-dimensional array of lenslets formed on a supporting substrate. Each lenslet may serve to focus and concentrate light from an optical fiber bonded to the substrate, for example, on an opposite surface of the substrate at a location corresponding to the lenslet.

A sheath 130 surrounds a portion of the fiber array, i.e., the portion adjacent the substrate 110, including the uncoated end portion 124 of the optical fibers and a coated portion 126 of the optical fibers. In the embodiment illustrated in FIG. 1, the sheath 130 is fabricated using two sections, a rear section 132 and a front section 134. These sections are semi-cylindrical sections formed by dividing a cylinder having a first base and a second base opposing the first base along the height of the cylinder, which runs parallel to the plurality of optical fibers 120 in FIG. 1. By using separate parts (e.g., two semi-cylindrical sections) to form the sheath 130, the rear section 132 and the front section 134 can be directly added around the fiber array, avoiding sliding of the sheath 130 along the longitudinal axis (i.e., the z-axis) of the plurality of optical fibers and the associated mechanical perturbation of the plurality of optical fibers 120 and the fragile weld joint formed at the end of the optical fibers and the substrate that could occur during sliding of the sheath 130 along the plurality of optical fibers 120 toward the substrate 110. In some implementations, a removeable adhesive can be applied to the bonding interface between the optical fibers and the substrate (e.g., the weld interface) to temporarily strengthen the weld joint during installation of the sheath. This removeable adhesive can then be removed by heat or chemical treatment before hermetic sealing of the sheath.

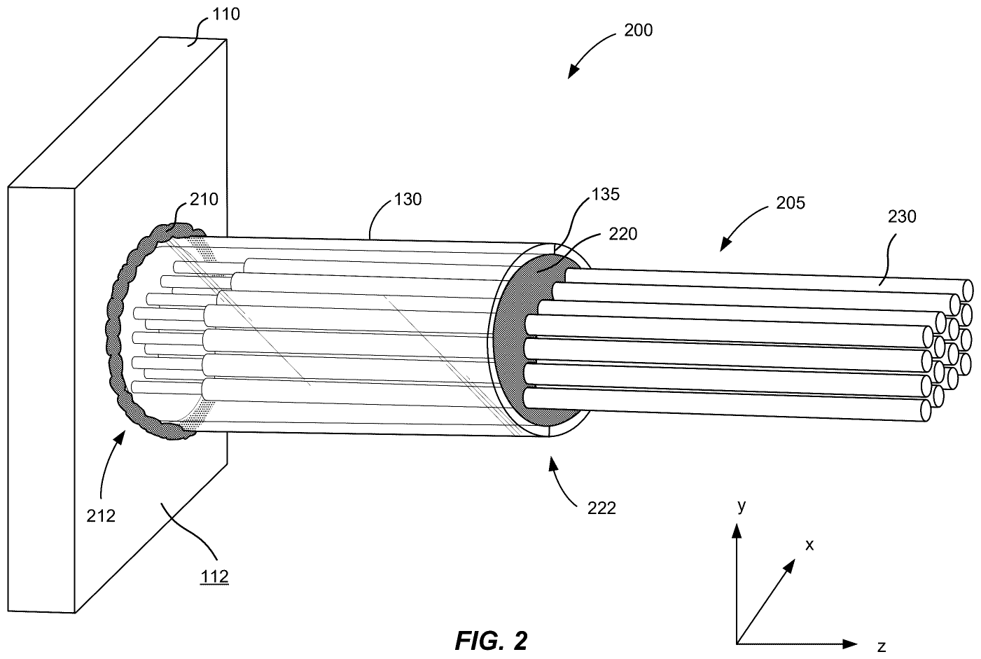

In other embodiments, the sheath 130 could be a single structure, for example, a glass cylinder, that can be slid over the plurality of optical fibers 120 toward the substrate 110, i.e., from the right to the left in FIG. 1. Although not shown in FIG. 1, the rear section 132, which is disposed on a first side, i.e., the back side, of the fiber array and the front section 134, which is disposed on a second side of the fiber array opposing the first side, i.e., the front side, can be bonded at joint 135 using epoxy or other suitable bonding material. Joint 135 is formed between the set of two joints on each of the first section and the second section. One of skill in the art will appreciate that bonding of the various structures illustrated herein is performed as appropriate to the particular application as discussed in relation to FIG. 2. It will be appreciated that the sheath 130 can have one of a range of lengths. As illustrated, a significant amount of the coated portion 126 of the plurality of optical fibers 120 is encapsulated by the sheath 130. However, in other embodiments, the sheath 130 is shorter, ending at the transition from uncoated end portion 124 of the plurality of optical fibers 120 to the coated portion 126 of the plurality of optical fibers 120.

FIG. 2 is a simplified schematic diagram of a sealed fiber array package 200 according to an embodiment of the present invention. The embodiment illustrated in FIG. 2 shares common elements with the embodiment illustrated in FIG. 1 and the description provide in relation to FIG. 1 is applicable to FIG. 2 as appropriate.

In FIG. 2, sheath 130 includes a first end 212 abutting the substrate 110 and a second end 222 distal from the substrate. The length of the sheath is defined by the distance between the first end 212 (also referred to as a first base) and the second end 222 (also referred to as a second base opposing the first base) measured along the longitudinal axis, i.e., the z-axis. The sheath 130 at least partially surrounds the fiber array in the sense that a portion of the length of the fiber array 205, including coated portions of the optical fibers 230 in the fiber array 205 and uncoated portions of the optical fibers 230 in the fiber array 205 are surrounded by the sheath 130. Thus, the sheath fully surrounds the fiber array in a number of x-y planes positioned at a range of longitudinal values (i.e., over a range of z-values).

Referring to FIG. 2, a first seal 210 is formed at a first end 212 of the sheath 130 abutting the substrate 110. The first seal 210, which can be formed using a ring of epoxy, bonds the first end 212 of the sheath 130 (i.e., the end of the sheath proximal to the substrate) to the substrate 110. As shown in FIG. 2, the first seal 210 surrounds the sheath 130 to form a continuous seal between the first end 212 of the sheath 130 and the welding surface 112 of the substrate 110.

A second seal 220 is formed at a second end 222 of the sheath 130. The second seal 220, which can also be formed using epoxy, bonds the second end 222 of the sheath 130 to the fibers of the plurality of optical fibers in the fiber array 205. As shown in FIG. 2, the second seal 220 surrounds the coated portions of the optical fibers 230 in the fiber array 205 to form a continuous seal between each of the optical fibers 230 in the fiber array 205 and between the fiber array 205 and the sheath 130. The second seal 220 is spatially separated from the first seal 210 along the longitudinal dimension of the fiber array (i.e., aligned with the z-axis), and provides strain relief for the optical fibers 230 in the fiber array 205. Although not shown in FIG. 2, the two sections making up sheath 130 (e.g., rear section 132 and front section 134) are joined, e.g., bonded with epoxy, at joint 135 between the two sections. One of ordinary skill in the art would recognize many variations, modifications, and alternatives.

As a result of the first seal 210 at the first end 212 of the sheath 130 and the second seal 220 at the second end 222 of the sheath 130, a sealed environment is formed inside the sheath 130, for example, a hermetically sealed environment. In addition to epoxy, other materials that can flow between the fibers and form a bond between adjacent fibers and a sealed environment inside the sheath can also be utilized.

In some embodiments, because of the small volume of epoxy used to form the first seal 210 and the second seal 220, adverse impacts of shrinkage of the epoxy during curing are avoided. Moreover, because the first seal 210 and the second seal 220 are spatially separated by a distance measured along the z-axis (i.e., the longitudinal dimension (length) of the sheath 130), the second seal 220 is formed at coated portions of the fibers (see coated portion 126 in FIG. 1) and does not make contact with the uncoated portions of the fibers (see uncoated end portion 124 in FIG. 1), which are welded to the substrate 110 and positioned inside the sheath 130 at the first end 212 of the sheath 130. Additionally, this spatial separation (e.g., a distance measured in centimeters along the z-axis) enables pressure to be applied to the optical fibers at the second seal 220 with no substantial impact on the fiber welds positioned at the first end 212 of the sheath 130 and separated by this longitudinal distance measured along the z-axis from the second end 222 of the sheath 130 and the second seal 220.

In embodiments in which the sheath is fabricated using fused silica, the CTE of the optical fibers and the sheath can be equal, preventing expansion mismatch with respect to the sheath and the optical fibers as the operating temperature of the sealed fiber array package 200 varies, for example, from −40° C. to 85° C. Moreover, this CTE match between fibers and sheath also enables the use of a wide range of epoxies due to the small volume of epoxy and the limited physical contact between the sheath, the epoxy, and the fibers.

The inside of the sheath 130 (e.g., a glass tube) can be hollow (e.g., filled with room air present in the ambient environment when the sealed fiber array package 200 is assembled). In other embodiments, since moisture can adversely impact the uncoated portion of the optical fibers, the sheath 130 can be filled with other gas, for example nitrogen or other inert gas or combinations of inert gases, can be a vacuum, or the sheath can contain a desiccant. In other embodiments, the sheath can be filled with a gel, grease, or other potting material to provide additional environmental protection. Instead of using epoxy to form the first seal 210 and/or the second seal 220, the sheath 130 can be attached to the substrate 110 using laser welding, optical bonding, molecular bonding, or other suitable bonding techniques.

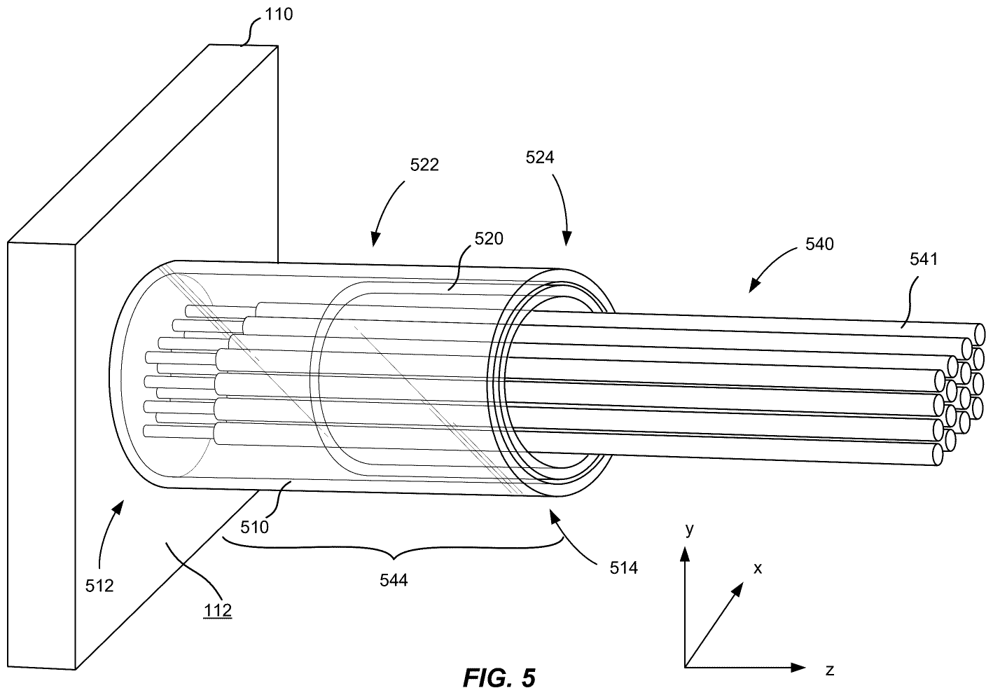

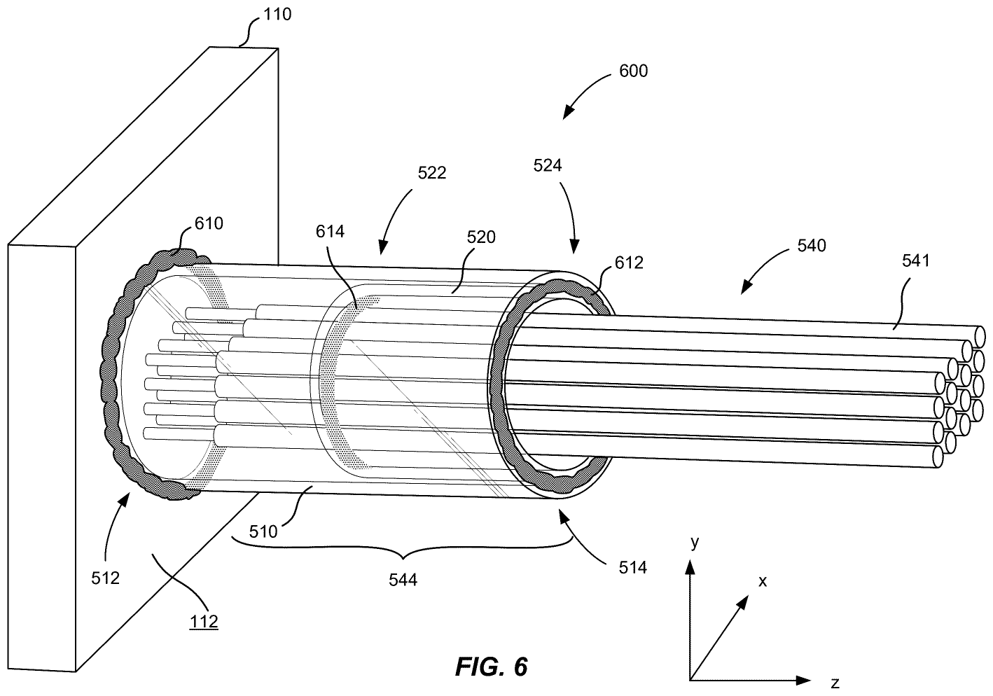

The sheath 130 can be fabricated as a glass tube or the glass tube can be replaced by multiple shells of different material(s) to achieve the same net effect or a single material to achieve athermalization, e.g., an aluminum/allvar composite. As discussed in relation to FIGS. 5 and 6 below, multiple sheaths could be made out of different materials to achieve athermalization, for example, an aluminum/allvar composite structure could be used to achieve net zero piston motion. One of ordinary skill in the art would recognize many variations, modifications, and alternatives.

Although a planar substrate is illustrated in FIGS. 1 and 2, embodiments of the present invention are applicable to a variety of substrates. Thus, in addition to an MLA, embodiments of the present invention are applicable to an all-glass beam combiner, or other optical component in which the epoxy is spatially separated from the fiber/substrate interface, particularly in embodiments in which there is high-power retro-reflection.

As illustrated in FIG. 2, additional benefits are provided by embodiments of the present invention. As an example, additional stiffness is provided by the sheath (e.g., a glass tube), which improves the lifetime of welded joints by reducing or eliminating static fatigue of the weld joint, increases the stiffness-mass ratio, and improves vibrational performance, which is an important factor for welded fibers. Moreover, additional thermal stress can arise when mounting the substrate into another housing. Accordingly, placement and bonding of the sheath can be used as means of athermalizing the overall assembly of the components and/or the sealed fiber array package 200.

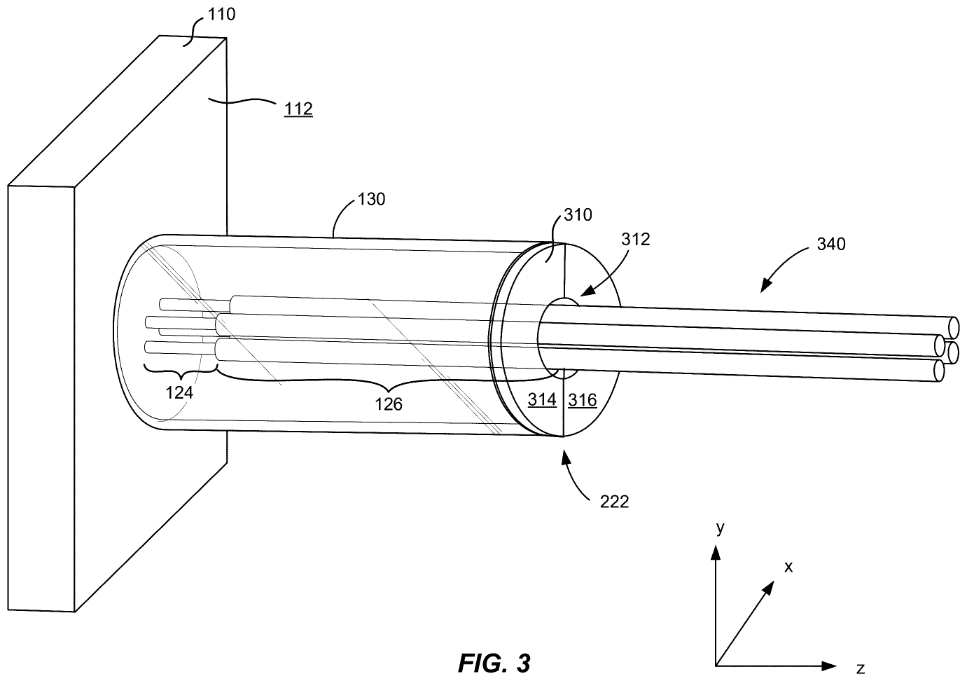

FIG. 3 is a simplified schematic diagram of a fiber array surrounded by a sheath capped by a disk according to an embodiment of the present invention. In FIG. 3, a disk 310 with an aperture 312 is positioned at the second end 222 of the sheath 130. In this embodiment, the disk 310 is formed by two half-annuluses (i.e., first half-annulus 314 and second half-annulus 316) that are joined to form the disk 310 in the form of an annulus at the second end 222 of the sheath 130. As discussed with respect to the sheath 130 illustrated FIG. 1, the two portions of the disk (i.e., first half-annulus 314 and second half-annulus 316) can be positioned at the second end 222 of the sheath 130 without making contact with the fiber array 340. Thus, this design contrasts with the use of an annulus that would need to be slid along the length of the fiber array in that the first portion of the disk can be positioned at the second end 222 of the sheath 130 by sliding the first portion of the disk along the x-axis (including adjustment along the y-axis as needed) with substantially no motion along the z-axis and the second portion of the disk can be positioned at the second end 222 of the sheath 130 by sliding the second portion of the disk along the-x-axis (including adjustment along the y-axis as needed) with substantially no motion along the z-axis. Although not shown in FIG. 3, the two half-annuluses (e.g., first half-annulus 314 and second half-annulus 316) can be bonded to each other as well as to the sheath 130 using epoxy or other suitable bonding material. One of skill in the art will appreciate that bonding of the various structures illustrated herein is performed as appropriate to the particular application although not illustrated in the figures.

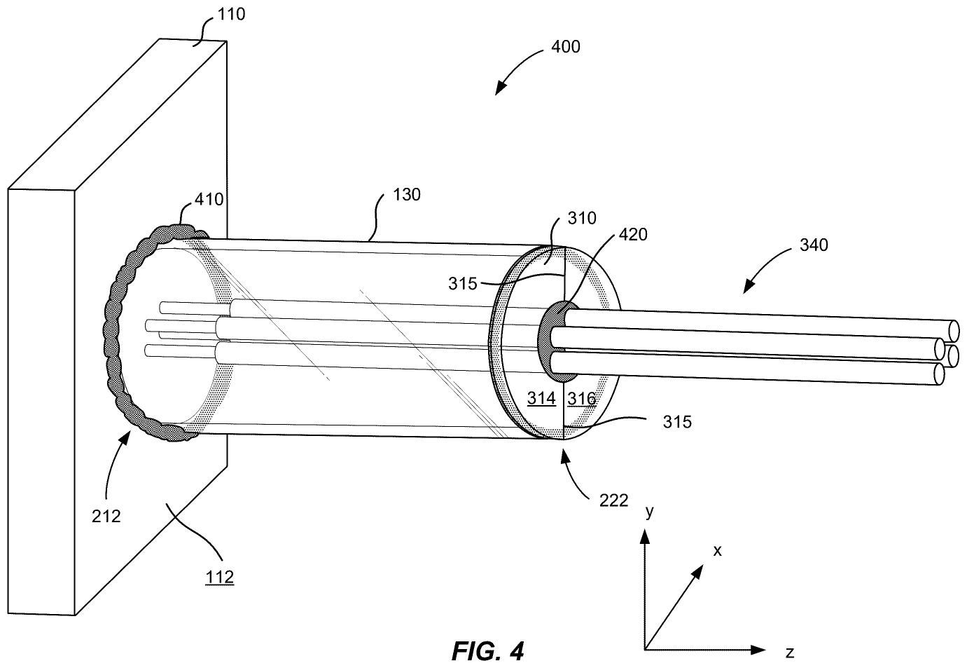

FIG. 4 is a simplified schematic diagram of a sealed fiber array package 400 including a sheath capped by a disk according to an embodiment of the present invention. The disk 310 is formed by two half-annuluses (e.g., first half-annulus 314 and second half-annulus 316). The sealed fiber array package 400 shares common elements with the embodiment illustrated in FIG. 3 and the description provided in relation to FIG. 3 is applicable to FIG. 4 as appropriate.

In FIG. 4, a bonding material, e.g., epoxy, has been used to form a hermetically sealed environment inside the sheath 130. The sheath 130 is bonded to the substrate 110 at the first end 212 of the sheath 130 to form first seal 410. The outer perimeter of the disk 310 is bonded to the sheath 130, for example, using epoxy, and the inner perimeter of the disk 310 is bonded to the optical fibers in the fiber array 340. Each of the optical fibers is also bonded to adjacent fibers to form a continuously sealed second seal 420. Thus, the optical fibers of the fiber array 340 extend through the aperture at the center of the disk 310 (see aperture 312 illustrated in FIG. 3) and are sealed to each other and to the disk 310 in the plane of the disk, which lies in the x-y plane, for example, using epoxy. Although not shown in FIG. 4, the two half-annuluses (e.g., first half-annulus 314 and second half-annulus 316) forming the disk 310 are joined, e.g., bonded with epoxy, at joint 315 between the two half-annuluses. One of ordinary skill in the art would recognize many variations, modifications, and alternatives.

As discussed above and in relation to FIG. 2, the first end 212 of the sheath 130 is bonded to the substrate 110. In some embodiments, the sheath 130 is brought into contact with the substrate 110 and then the epoxy is added at the periphery of the sheath 130 so that no epoxy is present inside the sheath 130 at the welding surface 112 of the substrate 110, thereby preventing contact between the optical fibers in the fiber array 340, in particular, the uncoated portion of the optical fibers, and the epoxy.

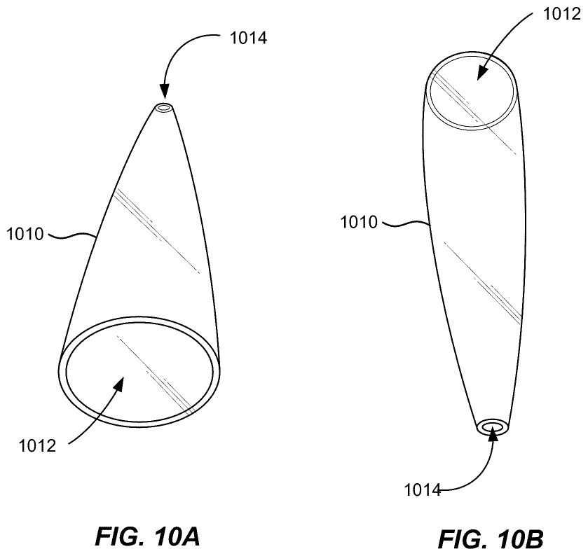

In some embodiments, the sheath 130 and the disk 310 could be manufactured as a single structure, for example, a cylinder with no bottom and a top including a centrally located aperture. This single structure could then be cut lengthwise to form two sections. Each section could then be positioned abutting the substrate with the fiber array passing through the half aperture present at the top of the section. Moreover, in an embodiment in which a conic section is utilized instead of a cylindrical structure for the sheath, as illustrated in FIG. 10, the conic section with an aperture at the top of the conic section could be cut lengthwise to form two semi-conic sections that could then be positioned abutting the substrate with the fiber array passing through the half aperture present at the top of each of the semi-conic sections. One of ordinary skill in the art would recognize many variations, modifications, and alternatives to these clamshell arrangements.

The shape of the sheath does not need to be a cylinder and other shapes can be utilized, including the conical shapes shown in FIG. 10 and tubular elements with square or rectangular cross sections, or the like.

Thus, embodiments of the present invention provide an implementation that can be a glass tube with a cap. In this embodiment, a round glass plate with a small hole cut in it for the fiber array to pass through can be cut in half to avoid having to slip the plate with the hole over the length of the welded fibers since the plate may contact the fibers during assembly and cause stress to the weld joints. In another embodiment, an implementation it utilized with a tapered glass tube as shown in FIG. 10. This tapered sheath can be a single piece that is slipped along welded fibers or can be cut in half and applied in two parts like a clamshell in order to avoid slipping sheath along the fibers.

FIG. 5 is a simplified schematic diagram of a fiber array surrounded by two sheaths according to an embodiment of the present invention. In the embodiment illustrated in FIG. 5, a first sheath 510 abuts the substrate 110 and a second sheath 520 is positioned inside the first sheath 510 at a position distal from the substrate 110 such that the second end 524 of the second sheath 520 is positioned surrounding the coated portion 544 of the optical fibers 541 in the fiber array 540. The first sheath 510 is longer than the second sheath 520. As discussed more fully in relation to FIG. 6, the first end 512 of the first sheath 510 is attached to the substrate 110 (e.g., a glass plate) to form a first end of a hermetically sealed structure, the second end 524 of the second sheath 520 is attached to the second end 514 of the first sheath 510 at the end of the first sheath 510 distal from the substrate 110, and the first end 522 of the second sheath 520 is attached to the coated portion 544 of the optical fibers 541 of the fiber array 540 at a longitudinal position between the first end 512 of the first sheath 510 and the second end 514 of the first sheath 510 as well as the second end 524 of the second sheath 520. Thus, the hermetically sealed structure extends from the substrate 110 to the first end 522 of the second sheath 520 and in the annular region between the second sheath 520 and the second end 514 of the first sheath 510.

The first sheath 510 and the second sheath 520 can slide along the longitudinal direction (i.e., the z-axis) so that they compensate for motion to achieve athermalization.

Accordingly, as the temperature varies, the expansion or contraction of the first sheath 510 and the second sheath 520 matches the expansion or contraction of the fiber array 540. Thus, as the operating temperature increases and the materials expand, the first sheath 510 (i.e., the outer shell) expands away from the substrate 110 and the second sheath 520 (i.e., the inner shell) expands towards the substrate 110 even as the second end 524 of the second sheath 520 moves with the first sheath 510 (i.e., the outer shell). The shell lengths and the shell CTEs can be used to match the length change experienced by the optical fibers.

FIG. 6 is a simplified schematic diagram of a sealed fiber array package 600 including two sheaths according to an embodiment of the present invention. The sealed fiber array package 600 shares common elements with the structure illustrated in FIG. 5 and the description provided in relation to FIG. 5 is applicable to FIG. 6 as appropriate.

Referring to FIG. 6, a bonding material, e.g., epoxy, has been used to form a hermetically sealed environment between the first sheath 510 and the second sheath 520. The first sheath 510 is bonded to the substrate 110 at the first end 512 of the first sheath 510 to form a first seal 610. Additionally, the second end 514 of the first sheath 510 is bonded to the second end 524 of the second sheath 520, for example, using epoxy, to form a second seal 612 bonding the inner surface of the second sheath 520 to the outer surface of the first sheath 510. At the first end 522 of the second sheath 520, the inner surface of the second sheath 520 is bonded to the coated portions of the optical fibers 541 in the fiber array 540 and the adjacent optical fibers are bonded to each other to form a third seal 614.

In a manner similar to the first seal 410 illustrated in FIG. 4, the first end 512 of the first sheath 510 is bonded to the substrate 110 such that the first sheath 510 is brought into contact with the substrate 110 and then the epoxy is added at the periphery of the first sheath 510 so that no epoxy is present inside the first sheath 510 at the welding surface 112 of the substrate 110, thereby preventing contact between the optical fibers 541 in the fiber array 540, in particular, the uncoated portion of the optical fibers, and the epoxy.

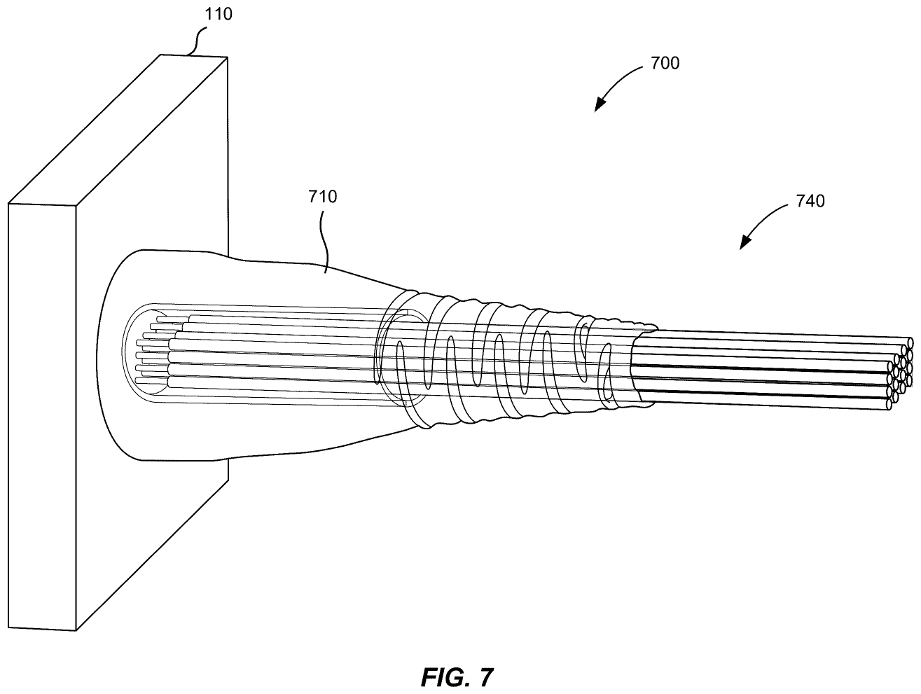

FIG. 7 is a simplified, partially transparent schematic diagram of a sealed fiber array package 700 according to an embodiment of the present invention. As shown in FIG. 7, a boot 710 encapsulates the sheath structure (the sheath structure used in conjunction with the sealed fiber array package 200 is illustrated in this embodiment) and allows the optical fibers in fiber array 740 to exit the boot 710. The boot 710 is typically made from rubber or an equivalent material. The boot is attached to the substrate (as shown) or a housing to which the substrate is mounted (not shown). Additionally, although not shown in FIG. 7, the fibers can be jacketed.

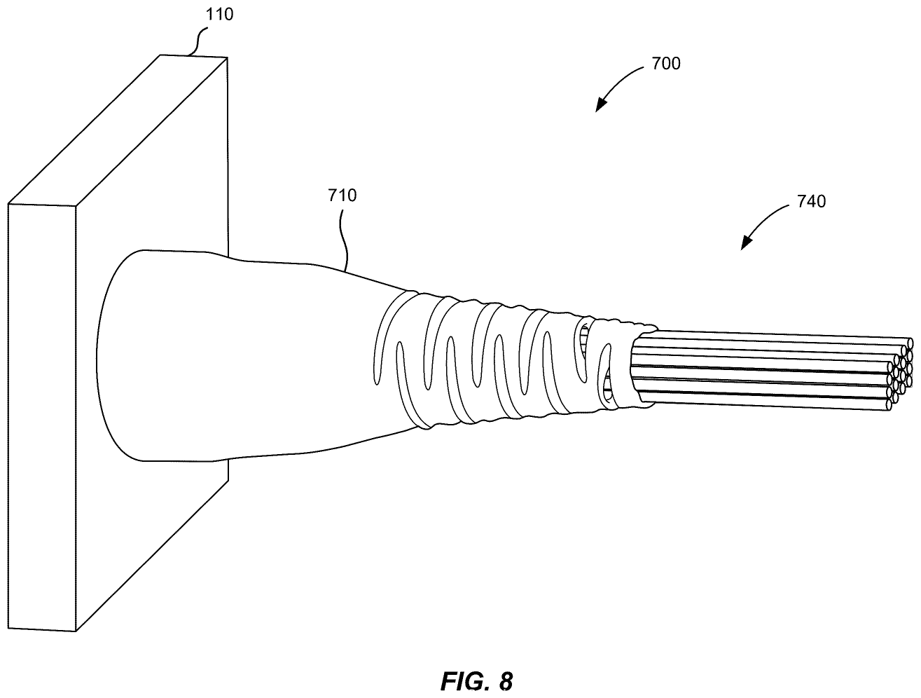

FIG. 8 is a simplified schematic diagram of a sealed fiber array package 700 mounted using boot 710 according to an embodiment of the present invention. As illustrated in FIG. 8 and discussed in relation to the partially transparent schematic diagram illustrated in FIG. 7, boot 710, i.e., a protective boot, is placed over the sheath (not shown) to protect the sealed fiber array package from shock, vibration, and/or other thermal or environmental perturbations.

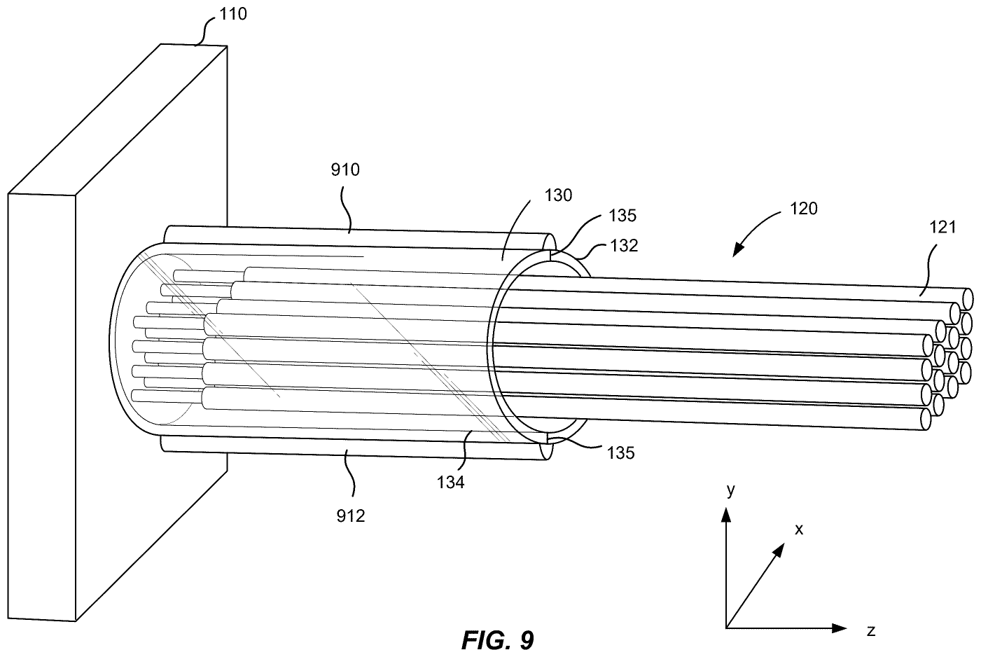

FIG. 9 is a simplified schematic diagram of a fiber array partially surrounded by a sheath with alignment features according to an embodiment of the present invention. For purposes of illustration, the sealed fiber array package 200 illustrated in FIG. 2 is utilized as an example.

As illustrated in FIG. 9, the sheath 130 (e.g., a glass tube) could be used as a primary alignment or mating feature for the overall assembly. In some embodiments, the alignment features can facilitate alignment of the sheath 130 to a connector, e.g., an optical connector.

As shown in FIG. 9, two alignment features, i.e., first alignment feature 910 and second alignment feature 912, are shown on the top and bottom surface of the sheath 130. Using the first alignment feature 910 and the second alignment feature 912, a housing (e.g., a plastic housing) can be slid over the sheath 130, using the first alignment feature 910 and the second alignment feature 912 as guides. As shown, the housing would have a notch corresponding to the alignment rail formed by the alignment features. The alignment features, i.e., the first alignment feature 910 and the second alignment feature 912 can be any shape or length and the half cylinder shown in FIG. 9 is merely exemplary. Moreover, there can be one or more alignment features and the two illustrated are merely exemplary. Although the alignment features are illustrated at the joint 135 between the rear section 132 (e.g., the first section) and the front section 134 (e.g., the second section) of the sheath 130, this is not required and the alignment features could be offset by 90 degrees, or other suitable offset, with respect to the positions shown in FIG. 9.

FIG. 10A is a simplified schematic diagram of a conical sheath from a bottom perspective according to an embodiment of the present invention. FIG. 10B is a simplified schematic diagram of the conical sheath from a top perspective according to an embodiment of the present invention.

In FIG. 10A, the conical sheath 1010 is illustrated from a bottom perspective in which wide aperture 1012 is mounted adjacent to the substrate 110 illustrated in FIG. 1. The plurality of optical fibers 120 would then pass through conical sheath 1010 and exit at narrow aperture 1014. As discussed above, in the embodiment illustrated in FIG. 10A, the conical sheath 1010 is a conic section with a wide aperture 1012 suitable for bonding to the substrate (e.g., the substrate 110 illustrated in FIG. 1) and a narrow aperture 1014 at the top of the conic section through which the optical fibers (e.g., the plurality of optical fibers 120 illustrated in FIG. 1) exit.

In the top perspective view illustrated in FIG. 10B, the narrow aperture 1014 of the conical sheath 1010 is illustrated as open with the wide aperture 1012 being illustrated in a hidden view. The plurality of optical fibers 120 entering through the wide aperture 1012 would exit from the conical sheath 1010 at the narrow aperture 1014 and extend in a downward direction.

The conic section could be cut lengthwise to form two semi-conic sections that could then be positioned abutting the substrate with the fiber array passing through the half aperture present at the top of each of the semi-conic sections. This design would include a rear section and a front section joined at a joint and share common elements with sheath 130 illustrated in FIG. 1 in which rear section 132 and front section 134 are joined at joint 135, for example, using epoxy.

In some embodiments, the spacing between optical fibers can be greater at wide aperture 1012 and less at narrow aperture 1014. As an example, at wide aperture 1012, the spacing between optical fibers at the location where the optical fibers are mounted to the substrate can be 500 μm center-to-center, enabling automated laser welding of the optical fibers to the substrate. As the optical fibers extend through conical sheath 1010, the spacing between the optical fibers can decrease, for example, to a center-to-center spacing of 150 μm for the 125 μm diameter optical fibers, leaving a space between optical fibers of 25 μm. In other embodiments, the space either at the wide aperture end (e.g., the substrate end) or the narrow aperture end can be larger or smaller depending on the particular application and the viscosity of the sealant (e.g., epoxy) used to seal the conical sheath 1010 to the substrate and/or the sealant (e.g., epoxy) used to seal the optical fibers to each other and the narrow aperture 1014 of the conical sheath 1010. Thus, the cross-section of the plurality of optical fibers can be decreased as the optical fibers pass through the conical sheath 1010 as appropriate to the particular application.

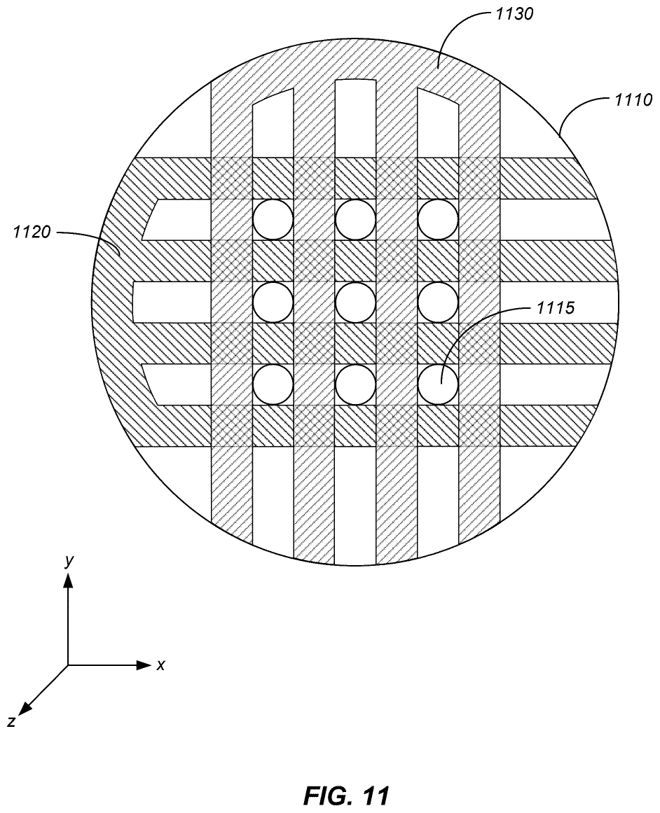

FIG. 11 is a simplified schematic plan view of a sheath with interdigitated support combs according to an embodiment of the present invention. Referring to FIG. 11, the distal end 1110 of the sheath is illustrated. The embodiment illustrated in FIG. 11 can be utilized in conjunction with any of the sheaths discussed in relation to FIGS. 2, 4, 6, or 9. As illustrated in FIG. 11, the optical fibers 1115 extend through the distal end 1110 of the sheath. In order to provide for controlled spacing between the optical fibers 1115 in the y-direction, a first interdigitated comb 1120 is inserted between the optical fibers 1115 in a direction parallel to the x-y plane. First interdigitated comb 1120 has fingers extending along the x-axis and defines the spatial separation between optical fibers 1115 in the y-direction.

In order to provide for controlled spacing between the optical fibers 1115 in the x-direction, a second interdigitated comb 1130 is inserted between the optical fibers 1115 in a direction parallel to the x-y plane. Second interdigitated comb 1130 has fingers extending along the y-axis and defines the spatial separation between optical fibers 1115 in the x-direction. In some embodiments, the first interdigitated comb 1120 and the second interdigitated comb 1130 are positioned at different longitudinal positions adjacent to each other, whereas in other embodiments, the interdigitated combs can be notched so that they can be positioned in the same longitudinal plane. Although not shown in FIG. 11 for purposes of clarity, epoxy can then be added to form a seal similar to the second seal 220 illustrated in FIG. 2.

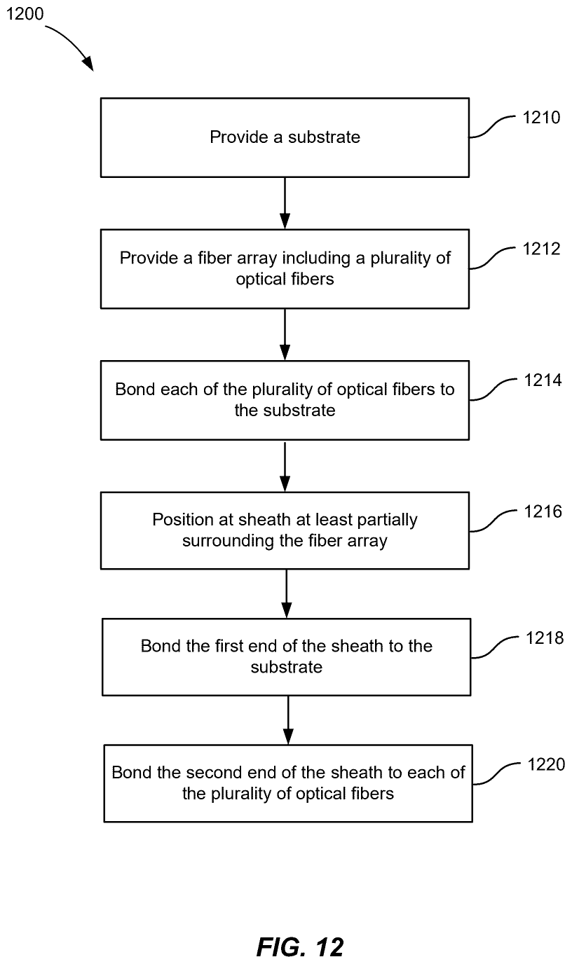

FIG. 12 is a simplified flowchart illustrating a method of fabricating a sealed fiber array package according to an embodiment of the present invention. The method 1200 includes providing a substrate (1210), providing a fiber array including a plurality of optical fibers (1212), and bonding each of the plurality of optical fibers to the substrate (1214). The substrate can be a microlens array. In some embodiments, bonding each of the plurality of fibers to the substrate includes welding (e.g., laser welding) each of the plurality of optical fibers (e.g., uncoated sections of each of the plurality of optical fibers) to the substrate.

The method 1200 also includes positioning a sheath at least partially surrounding the fiber array (1216). The sheath includes a first end abutting the substrate and a second end distal from the substrate. The sheath surrounds uncoated portions of each optical fiber of the plurality of optical fibers and coated portions of each optical fiber of the plurality of optical fibers in some embodiments. The sheath can be a cylinder as illustrated in FIG. 2. In an exemplary embodiment, the sheath, which can be made of fused silica, includes a first base that abuts and is bonded to the substrate and a second base that opposes the first base and includes an aperture.

The second seal can be formed in the aperture in the second base. As discussed in relation to FIGS. 3 and 4, the cylindrical sheath can be formed from a set of semi-cylindrical sections that are bonded at a joint.

The method further includes bonding the first end of the sheath to the substrate (1218) and bonding the second end of the sheath to each of the plurality of optical fibers (1220). As an example, bonding the first end of the sheath to the substrate can include forming a first seal by laser welding the first end of the sheath to the substrate. Bonding the second end of the sheath to each of the plurality of optical fibers can include bonding the second end of the sheath to peripheral optical fibers of the plurality of optical fibers and bonding the peripheral optical fibers of the plurality of optical fibers to adjacent optical fibers of the plurality of optical fibers.

The bond between the first end of the sheath and the substrate can be a first seal formed as a ring of epoxy bonded to the substrate and surrounding the first end of the sheath. In another embodiment, the first seal can be formed by laser welding the first end of the sheath to the substrate. Similarly, the bond between the second end of the sheath and the plurality of optical fibers can be a second seal formed by placing a bonding material between the second end of the sheath and peripheral optical fibers of the plurality of optical fibers and between adjacent optical fibers of the plurality of optical fibers. In some embodiments, the second seal can include a substantially planar annulus of epoxy bonded to the second end of the sheath and each optical fiber of the plurality of optical fibers. In other embodiments, the second seal can include a disk with an aperture partially filled with epoxy in portions of the disk free of the optical fibers. The disk can be formed by two half-annuluses joined with epoxy. Thus, embodiments of the present invention provide a sealed fiber array package that includes a hermetically sealed environment inside the sheath.

Although some embodiments utilize a cylindrical sheath, other embodiments utilize a sheath that is a conic section including a base proximal to the substrate and an aperture distal from the substrate. In these embodiments, the conic section can be formed using two semi-conic sections joined longitudinally.

It should be appreciated that the specific steps illustrated in FIG. 12 provide a particular method of fabricating a sealed fiber array package according to an embodiment of the present invention. Other sequences of steps may also be performed according to alternative embodiments. For example, alternative embodiments of the present invention may perform the steps outlined above in a different order. Moreover, the individual steps illustrated in FIG. 12 may include multiple sub-steps that may be performed in various sequences as appropriate to the individual step. Furthermore, additional steps may be added or removed depending on the particular applications. One of ordinary skill in the art would recognize many variations, modifications, and alternatives.

Various examples of the present disclosure are provided below. As used below, any reference to a series of examples is to be understood as a reference to each of those examples disjunctively (e.g., “Examples 1-4” is to be understood as “Examples 1, 2, 3, or 4”).

Example 1 is a sealed fiber array package comprising: a substrate; a fiber array including a plurality of optical fibers, wherein each optical fiber of the plurality of optical fibers is bonded to the substrate; a sheath at least partially surrounding the fiber array, wherein the sheath has a first end abutting the substrate and a second end distal from the substrate; a first seal disposed at the first end of the sheath; and a second seal disposed at the second end of the sheath.

Example 2 is the sealed fiber array package of example 1 wherein the substrate comprises a microlens array.

Example 3 is the sealed fiber array package of example(s) 1-2 wherein each optical fiber of the plurality of optical fibers is welded to the substrate.

Example 4 is the sealed fiber array package of example(s) 1-3 wherein each optical fiber of the plurality of optical fibers is laser welded to the substrate.

Example 5 is the sealed fiber array package of example(s) 1-3 wherein each optical fiber of the plurality of optical fibers comprises an uncoated portion welded to the substrate.

Example 6 is the sealed fiber array package of example(s) 1-5 wherein the sheath surrounds uncoated portions of each optical fiber of the plurality of optical fibers and coated portions of each optical fiber of the plurality of optical fibers.

Example 7 is the sealed fiber array package of example(s) 1-6 wherein the sheath comprises a cylinder.

Example 8 is the sealed fiber array package of example(s) 1-7 wherein the cylinder comprises a first base and a second base opposing the first base, wherein the second base comprises an aperture and the second seal is formed in the aperture.

Example 9 is the sealed fiber array package of example(s) 1-8 wherein the sheath comprises fused silica.

Example 10 is the sealed fiber array package of example(s) 1-9 wherein the sheath comprises a set of semi-cylindrical sections.

Example 11 is the sealed fiber array package of example(s) 1-10 wherein the first seal comprises a ring of epoxy bonded to the substrate and surrounding the first end of the sheath.

Example 12 is the sealed fiber array package of example(s) 1-11 wherein the first seal comprises a laser weld between the substrate and the first end of the sheath.

Example 13 is the sealed fiber array package of example(s) 1-12 wherein the second seal comprises a bonding material disposed between the second end of the sheath and peripheral optical fibers of the plurality of optical fibers and between adjacent optical fibers of the plurality of optical fibers.

Example 14 is the sealed fiber array package of example(s) 1-13 wherein the second seal comprises a substantially planar annulus of epoxy bonded to the second end of the sheath and each optical fiber of the plurality of optical fibers.

Example 15 is the sealed fiber array package of example(s) 1-14 wherein the second seal comprises a disk with an aperture partially filled with epoxy.

Example 16 is the sealed fiber array package of example(s) 1-15 wherein the disk comprises two half-annuluses joined with epoxy.

Example 17 is the sealed fiber array package of example(s) 1-16 wherein the sealed fiber array package includes a hermetically sealed environment inside the sheath.

Example 18 is the sealed fiber array package of example(s) 1-17 wherein the sheath comprises a conic section including an aperture.

Example 19 is the sealed fiber array package of example(s) 1-18 wherein the conic section comprises two semi-conic sections joined longitudinally.

Example 20 is a sealed fiber array package comprising: a substrate; a fiber array including a plurality of optical fibers, wherein each optical fiber of the plurality of optical fibers is bonded to the substrate; a sheath at least partially surrounding the fiber array, wherein the sheath comprises: a first section disposed on a first side of the fiber array and including a set of first joints; a second section disposed on a second side of the fiber array opposing the first side and including a set of second joints, wherein the first joints are bonded to the second joints; and a set of half-annuluses joined to the first section and the second section and defining an aperture, wherein the fiber array extends through the aperture; a first seal formed between the substrate and the sheath; and a second seal formed in the aperture.

Example 21 is the sealed fiber array package of example 20 wherein the sheath comprises a cylinder including a base proximal to the substrate.

Example 22 is the sealed fiber array package of example(s) 20-21 wherein the first section and the second section comprise semi-cylindrical sections.

Example 23 is the sealed fiber array package of example(s) 20-22 wherein the sheath comprises a conic section.

Example 24 is the sealed fiber array package of example(s) 20-23 wherein the conic section comprises two semi-conic sections joined longitudinally.

Example 25 is the sealed fiber array package of example(s) 20-24 wherein the sheath comprises fused silica.

Example 26 is the sealed fiber array package of example(s) 20-25 wherein the substrate comprises a microlens array.

Example 27 is the sealed fiber array package of example(s) 20-26 wherein each optical fiber of the plurality of optical fibers is laser welded to the substrate.

Example 28 is the sealed fiber array package of example(s) 20-27 wherein each optical fiber of the plurality of optical fibers comprises an uncoated portion welded to the substrate.

Example 29 is the sealed fiber array package of example(s) 20-28 wherein the sheath surrounds uncoated portions of each optical fiber of the plurality of optical fibers and coated portions of each optical fiber of the plurality of optical fibers.

Example 30 is the sealed fiber array package of example(s) 20-29 wherein: the sheath comprises a first end abutting the substrate and a second end distal from the substrate; and the first seal comprises a ring of epoxy bonded to the substrate and surrounding the first end of the sheath.

Example 31 is the sealed fiber array package of example(s) 20-30 wherein: the sheath comprises a first end abutting the substrate and a second end distal from the substrate; and the first seal comprises a laser weld between the substrate and the first end of the sheath.

Example 32 is the sealed fiber array package of example(s) 20-31 wherein the second seal comprises a bonding material disposed between the aperture and peripheral optical fibers of the plurality of optical fibers and between adjacent optical fibers of the plurality of optical fibers.

Example 33 is the sealed fiber array package of example(s) 20-32 wherein the sealed fiber array package includes a hermetically sealed environment inside the sheath.

Example 34 is a method of fabricating a sealed fiber array package, the method comprising: providing a substrate; providing a fiber array including a plurality of optical fibers; bonding each of the plurality of optical fibers to the substrate; positioning a sheath at least partially surrounding the fiber array, wherein the sheath comprises a first end abutting the substrate and a second end distal from the substrate; bonding the first end of the sheath to the substrate; and bonding the second end of the sheath to each of the plurality of optical fibers.

Example 35 is the method of example 34 wherein bonding each of the plurality of optical fibers to the substrate comprising laser welding uncoated sections of each of the plurality of optical fibers to the substrate.

Example 36 is the method of example(s) 34-35 wherein bonding the second end of the sheath to each of the plurality of optical fibers comprises joining peripheral optical fibers to the second end of the sheath with epoxy and joining each of the plurality of optical fibers to adjacent optical fibers with epoxy.

Example 37 is the method of example(s) 34-36 wherein the substrate comprises a microlens array.

Example 38 is the method of example(s) 34-37 wherein bonding each of the plurality of optical fibers to the substrate comprises welding each optical fiber of the plurality of optical fibers to the substrate.

Example 39 is the method of example(s) 34-38 wherein welding each optical fiber of the plurality of optical fibers to the substrate comprises laser welding each optical fiber of the plurality of optical fibers to the substrate.

Example 40 is the method of example(s) 34-38 wherein each optical fiber of the plurality of optical fibers comprises an uncoated portion welded to the substrate.

Example 41 is the method of example(s) 34-40 wherein the sheath surrounds uncoated portions of each optical fiber of the plurality of optical fibers and coated portions of each optical fiber of the plurality of optical fibers.

Example 42 is the method of example(s) 34-41 wherein the sheath comprises a cylinder.

Example 43 is the method of example(s) 34-42 wherein: the cylinder comprises a base and an aperture in the base; and bonding the second end of the sheath to each of the plurality of optical fibers comprises forming a seal in the aperture.

Example 44 is the method of example(s) 34-43 wherein the sheath comprises fused silica.

Example 45 is the method of example(s) 34-45 wherein the sheath comprises a set of semi-cylindrical sections.

Example 46 is the method of example(s) 34-45 wherein bonding the first end of the sheath to the substrate comprises forming a ring of epoxy bonded to the substrate and surrounding the first end of the sheath.

Example 47 is the method of example(s) 34-46 wherein bonding the first end of the sheath to the substrate comprises forming a first seal by laser welding the first end of the sheath to the substrate.

Example 48 is the method of example(s) 34-47 wherein bonding the second end of the sheath to each of the plurality of optical fibers comprises bonding the second end of the sheath to peripheral optical fibers of the plurality of optical fibers and bonding the peripheral optical fibers of the plurality of optical fibers to adjacent optical fibers of the plurality of optical fibers.

Example 49 is the method of example(s) 34-48 wherein bonding the second end of the sheath to each of the plurality of optical fibers comprises forming a substantially planar annulus of epoxy bonded to the second end of the sheath and each optical fiber of the plurality of optical fibers.

Example 50 is the method of example(s) 34-49 further comprising bonding a disk with an aperture to the second end of the sheath prior to bonding the second end of the sheath to each of the plurality of optical fibers.

Example 51 is the method of example(s) 34-50 wherein the disk comprises two half-annuluses joined with epoxy.

Example 52 is the method of example(s) 34-51 wherein the sealed fiber array package includes a hermetically sealed environment inside the sheath.

Example 53 is the method of example(s) 34-52 wherein the sheath comprises a conic section including an aperture.

Example 54 is the method of example(s) 34-53 wherein the conic section comprises two semi-conic sections joined longitudinally.

The technology described and claimed herein is not to be limited in scope by the specific preferred embodiments herein disclosed, since these embodiments are intended as illustrations, and not limitations, of several aspects of the technology. Any equivalent embodiments are intended to be within the scope of this technology. Indeed, various modifications of the technology in addition to those shown and described herein will become apparent to those skilled in the art from the foregoing description. Such modifications are also intended to fall within the scope of the appended claims.

What is claimed is:

1. A sealed fiber array package comprising:
a substrate;
a fiber array including a plurality of optical fibers, wherein each optical fiber of the plurality of optical fibers is bonded to the substrate;
a sheath at least partially surrounding the fiber array, wherein the sheath has a first end abutting the substrate and a second end distal from the substrate;
a first seal disposed at the first end of the sheath; and
a second seal disposed at the second end of the sheath.

2. The sealed fiber array package of claim 1 wherein the substrate comprises a microlens array.

3. The sealed fiber array package of claim 1 wherein each optical fiber of the plurality of optical fibers is welded to the substrate.

4. The sealed fiber array package of claim 3 wherein each optical fiber of the plurality of optical fibers is laser welded to the substrate.

5. The sealed fiber array package of claim 3 wherein each optical fiber of the plurality of optical fibers comprises an uncoated portion welded to the substrate.

6. The sealed fiber array package of claim 1 wherein the sheath surrounds uncoated portions of each optical fiber of the plurality of optical fibers and coated portions of each optical fiber of the plurality of optical fibers.

7. The sealed fiber array package of claim 1 wherein the sheath comprises a cylinder.

8. The sealed fiber array package of claim 7 wherein the cylinder comprises a first base and a second base opposing the first base, wherein the second base comprises an aperture and the second seal is formed in the aperture.

9. The sealed fiber array package of claim 1 wherein the sheath comprises fused silica.

10. The sealed fiber array package of claim 1 wherein the sheath comprises a set of semi-cylindrical sections.

11. The sealed fiber array package of claim 1 wherein the first seal comprises a ring of epoxy bonded to the substrate and surrounding the first end of the sheath.

12. The sealed fiber array package of claim 1 wherein the first seal comprises a laser weld between the substrate and the first end of the sheath.

13. The sealed fiber array package of claim 1 wherein the second seal comprises a bonding material disposed between the second end of the sheath and peripheral optical fibers of the plurality of optical fibers and between adjacent optical fibers of the plurality of optical fibers.

14. The sealed fiber array package of claim 1 wherein the second seal comprises a substantially planar annulus of epoxy bonded to the second end of the sheath and each optical fiber of the plurality of optical fibers.

15. The sealed fiber array package of claim 1 wherein the second seal comprises a disk with an aperture partially filled with epoxy.

16. The sealed fiber array package of claim 15 wherein the disk comprises two half-annuluses joined with epoxy.

17. The sealed fiber array package of claim 1 wherein the sealed fiber array package includes a hermetically sealed environment inside the sheath.

18. The sealed fiber array package of claim 1 wherein the sheath comprises a conic section including an aperture.

19. The sealed fiber array package of claim 18 wherein the conic section comprises two semi-conic sections joined longitudinally.
